(19) United States
(12) Patent Application Publication
(10) Pub. No.: US 2009/0071947 A1
(43) Pub. Date: Mar. 19, 2009

(54) LASER BEAM MACHINE

(75) Inventors: Hiroshi Sekiguchi, Hamamatsu-shi (JP); Hirofumi Miyajima, Hamamatsu-shi (JP)

Correspondence Address: DRINKER BIDDLE & REATH (DC), 1500 K STREET, N.W., SUITE 1100, WASHINGTON, DC, 20005-1209, US

(73) Assignee: HAMAMATSU PHOTONICS K.K., Hamamatsu-shi (JP)

(21) Appl. No.: 12/212,010

(22) Filed: Sep. 17, 2008

(30) Foreign Application Priority Data
Sep. 18, 2007 (JP) P2007-241251

(51) Int. Cl. B23K 26/02

(52) U.S. Cl. 219/121.75

(57) ABSTRACT

There is disclosed a laser beam machine including: a light source that emits a laser beam; an aperture in a flat plate shape and arranged in a manner crossing an optical axis direction of a laser beam from the light source, and having an opening to pass a laser beam from the light source therethrough; a focusing portion that is arranged at a side opposite to the light source with respect to the aperture, and focuses a laser beam that has passed through the opening of the aperture and irradiates the laser beam onto a workpiece, wherein the focusing portion imparts astigmatism to a laser beam that has passed through the opening of the aperture, a first focal line and a second focal line of the focusing portion are produced by the astigmatism, the first focal line is formed by focusing of a laser beam distributed in a first direction crossing the optical axis direction, the second focal line is formed by focusing of a laser beam distributed in a second direction crossing the optical axis direction and the first direction, and positions of the first focal line and the second focal line are different in the optical axis direction.

### BACKGROUND OF THE INVENTION

1. Field of the Invention

The present invention relates to a laser beam machine using a laser beam.

2. Related Background Art

A laser beam machine using a laser beam has been known as a machine that performs processings such as cutting, drilling, welding, and a surface treatment. Conventionally, in this type of laser beam machine, a YAG laser or a carbon dioxide laser that can be readily made to have a high power has been used as a light source. However, in line with the high power of semiconductor lasers in recent years, attention has focused on small-sized semiconductor lasers as light sources of laser beam machines.

In a laser processing using a laser beam machine, a laser beam irradiated onto a workpiece may be reflected, and when, for example, the workpiece is made of a metal, the intensity of reflected light from the workpiece is large. If such reflected light having a large intensity returns to a semiconductor laser, which is a light source of the laser beam machine, as a return light, there is a risk that the life of the semiconductor laser may be shortened or the semiconductor laser may break down.

In this regard, Japanese Published Unexamined Patent Application No. S62-289387 describes a laser beam machine that obliquely irradiates a laser beam onto a working surface of a workpiece. According to this laser beam machine, reflecting light to be reflected on the working surface of the workpiece can be prevented from returning to the light source.

### SUMMARY OF THE INVENTION

However, in an actual operating environment, the positional relationship between the laser beam machine and the workpiece may change, and in the laser beam machine described in Japanese Published Unexamined Patent Application No. S62-289387, the angle of inclination of a laser beam with respect to the working surface of the workpiece may become insufficient. For example, at the time of installation or adjustment of the laser beam machine, the time of replacement of the workpiece, and the like, the angle of inclination of a laser beam with respect to the working surface of the workpiece may become insufficient. Moreover, in such a case, for example, where the angle of the working surface of the workpiece momentarily changes with respect to a laser beam as a result of unevenness existing on the working surface of the workpiece, the angle of inclination of a laser beam with respect to the working surface of the workpiece may become insufficient. As a result, there is a possibility that light reflected from the workpiece returns to the light source as a return light.

It is therefore an object of the present invention to provide a laser beam machine that can reduce a return light to a light source without depending on the positional relationship with a workpiece.

A laser beam machine of the present invention includes (a) a light source that emits a laser beam, (b) an aperture in a flat plate shape and arranged in a manner crossing an optical axis direction of the laser beam from the light source, and having an opening to pass the laser beam from the light source therethrough, and (c) a focusing portion that is arranged at a side opposite to the light source with respect to the aperture, and focuses the laser beam that has passed through the opening of the aperture and irradiates the laser beam onto a workpiece, wherein (d) the focusing portion imparts astigmatism to the laser beam that has passed through the opening of the aperture, (e) a first focal line and a second focal line of the focusing portion are produced by the astigmatism, the first focal line is formed by focusing of a laser beam distributed in a first direction crossing the optical axis direction, the second focal line is formed by focusing of a laser beam distributed in a second direction crossing the optical axis direction and the first direction, and positions of the first focal line and the second focal line are different in the optical axis direction.

According to this laser beam machine, the focusing portion imparts astigmatism to a laser beam, and the positions of the first focal line and the second focal line are different in the optical axis direction, and thus a light reflected from a working surface of the workpiece has a beam diameter larger than an opening diameter in the aperture. Accordingly, the aperture blocks a part of the reflected light from the workpiece, and a return light that returns to the light source through the opening can be reduced.

Meanwhile, in an actual operating environment, the positional relationship between the laser beam machine and the workpiece may change, and at, for example, the time of installation or adjustment of the laser beam machine, the time of replacement of the workpiece, and the like, the position of the working surface of the workpiece may be coincident with the position of the first focal line in the optical axis direction. Then, a beam diameter in the first direction of the reflected light from the workpiece is focused to the opening diameter in the aperture. However, since the second focal line is produced at a position different from the position of the working surface of the workpiece, a beam diameter in the second direction of the reflected light from the workpiece is larger than the opening diameter in the aperture.

Similarly, even when the position of the working surface of the workpiece is coincident with the position of the second focal line in the optical axis direction and a beam diameter in the second direction of the reflected light from the workpiece is focused to the opening diameter in the aperture, since the first focal line is produced at a position different from the position of the working surface of the workpiece, a beam diameter in the first direction of the reflected light from the workpiece is larger than the opening diameter in the aperture.

Therefore, according to this laser beam machine, without depending on the positional relationship with the workpiece, the aperture blocks a part of the reflected light from the workpiece, and thus a return light that returns to the light source through the opening can be reduced.

It is preferable that a working surface of the workpiece mentioned above is set at a position sandwiched by the first focal line and the second focal line of the focusing portion in the optical axis direction.

According thereto, when, for example, the working surface of the workpiece is displaced to the side of one of the first and second focal lines in the optical axis direction, the distance between the working surface of the workpiece and the other of the first and second focal lines is increased. Accordingly, when the beam diameter in one of the first and second directions of the reflected light from the workpiece is reduced, the beam diameter in the other of the first and second directions is increased. Hence, variation in the effect to reduce a return light to the light source with respect to the positional relationship with the workpiece can be reduced.

It is preferable that a beam sectional shape of a laser beam on a working surface of the workpiece mentioned above is an ellipse.

According thereto, by changing a scanning direction of the laser beam on the workpiece, a laser beam machine suitable for a variety of processings can be realized. For example, when a laser beam is scanned on the workpiece in a longer direction, the laser beam intensity per unit area and unit time can be increased, so that a laser beam machine suitable for a processing, such as cutting or welding, that requires great power per unit area and unit time can be realized.

On the other hand, when a laser beam is scanned on the workpiece in a shorter direction, the laser beam irradiation area per unit time can be increased, so that a laser beam machine suitable for a processing, such as a surface treatment, that requires a large treatment area per unit time can be realized.

Moreover, according to the laser beam machine mentioned above, by changing the positional relationship between the first and second focal lines and the working surface of the workpiece in the optical axis direction, more specifically, by changing the positional relationship between the focusing portion and the workpiece in the optical axis direction, a beam sectional shape of a laser beam can be easily made into an ellipse, and the longer direction and shorter direction of a laser beam can be easily changed.

It is preferable to further include a cooler for the aperture.

Since the aperture blocks a part of the reflected light from the workpiece, the temperature of the aperture rises, and as a result, oxidation may rapidly progress in the aperture. The reflectivity lowers as oxidation progresses, and the aperture begins to absorb more return light. However, according to this construction, by including the cooler, a rise in temperature of the aperture can be suppressed, and as a result, deterioration of the aperture can be suppressed.

The focusing portion mentioned above may have a first optical element having a focusing effect in one direction being the first direction, and a second optical element having a focusing effect in one direction being the second direction. For example, the first optical element may include a first focusing lens that is arranged in a manner crossing the optical axis direction, and produces the first focal line as a result of having a cylindrical refractive index distribution in the first direction, and the second optical element may include a second focusing lens that is arranged in a manner crossing the optical axis direction and arranged apart from the first focusing lens in the optical axis direction, and produces the second focal line as a result of having a cylindrical refractive index distribution in the second direction.

According to these constructions, a focusing portion to impart astigmatism to a laser beam that has passed through the opening of the aperture can be easily realized.

Moreover, the focusing portion mentioned above may have a first optical element having a focusing effect in one direction being the first direction, and a second optical element having an isotropic focusing effect on a plane including the first direction and the second direction. For example, the first optical element may include a first focusing lens that is arranged in a manner crossing the optical axis direction, and produces the first focal line as a result of having a cylindrical refractive index distribution in the first direction, the second optical element may include a second focusing lens that is arranged in a manner crossing the optical axis direction and arranged apart from the first focusing lens in the optical axis direction, and has an isotropic refractive index distribution on a plane including the first direction and the second direction, and the focusing portion may produce the second focal line by focusing effects of the first focusing lens and the second focusing lens.

According to these constructions, a focusing portion to impart astigmatism to a laser beam that has passed through the opening of the aperture can be easily realized. Moreover, according to these constructions, by combining a cylindrical lens having a relatively long focal length and an aspherical lens (alternatively, an aplanatic lens or an achromatic lens) as the first and second focusing lenses, an astigmatic difference can be generated without producing a strong spherical aberration.

Moreover, the focusing portion may have a multifocal lens that is arranged in a manner crossing the optical axis direction, and produces the first and second focal lines as a result of having refractive index distributions in the first and second directions, respectively, or may have a spherical lens arranged in a manner crossing the optical axis direction and arranged in a manner inclined with respect to the optical axis direction.

According to these constructions, a focusing portion to impart astigmatism to a laser beam that has passed through the opening of the aperture can be easily realized.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a view showing a configuration of a laser beam machine according to a first embodiment of the present invention.

FIG. 2 is a view showing a beam sectional shape of a laser beam of the laser beam machine of FIG. 1 and a scanning direction of the laser beam on a workpiece W.

FIG. 3 is a view showing a beam sectional shape of a laser beam of the laser beam machine of FIG. 1 and a scanning direction of the laser beam on a workpiece W.

FIG. 4 is a view showing a configuration of a laser beam machine according to a second embodiment of the present invention.

FIG. 5 is a view showing a configuration of a laser beam machine according to a third embodiment of the present invention.

FIG. 6 is a view showing a configuration of a laser beam machine according to a fourth embodiment of the present invention.

FIG. 7 is a view showing an example of a multifocal lens for imparting astigmatism.

FIG. 8 is a front view showing a modification of an aperture.

FIG. 9 is a view showing a configuration of a laser beam machine according to a modification of the present invention.

### DESCRIPTION OF THE PREFERRED EMBODIMENTS

Hereinafter, preferred embodiments of the present invention will be described in detail with reference to the drawings. Also, the same or corresponding parts are denoted with the same reference numerals and characters in each drawing.

### First Embodiment

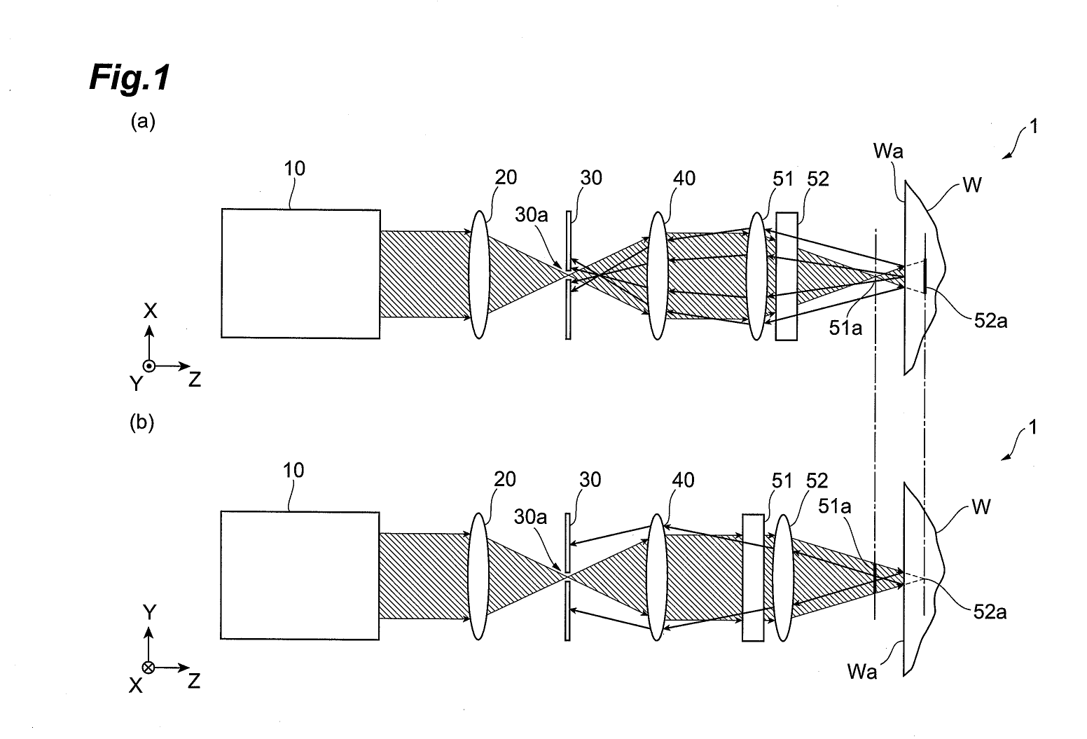

FIG. 1 is a view showing a configuration of a laser beam machine according to a first embodiment of the present invention. FIG. 1(a) is a front view of a laser beam machine 1, and FIG. 1(b) is a side view of the laser beam machine 1. Also, in FIGS. 1(a) and (b), shown is a workpiece W along with the laser beam machine 1.

The laser beam machine 1 includes a light source 10 and a focusing lens 20, an aperture plate 30 (aperture), a collimator lens 40, and first and second cylindrical lenses 51 and 52 (a focusing portion) arranged in order almost vertically to an optical axis direction Z of a laser beam emitted from the light source 10.

The light source 10 has, for example, a semiconductor laser, and emits a laser beam toward the focusing lens 20.

The focusing lens 20 focuses the laser beam from the light source 10, and outputs the same to the aperture plate 30.

The aperture plate 30 forms a flat plate shape, and in a central portion of the aperture plate 30, a hole 30a (aperture) to pass the laser beam from the focusing lens 20 therethrough is formed. For the material of the aperture plate 30, preferably used is a metal such as copper or aluminum having a high reflectivity to block light reflected from the workpiece W and having a high heat conductivity to suppress a rise in temperature due to the reflected light, as described below. Further, it is preferable to apply a surface treatment such as gold plating to the aperture plate 30 in order to enhance reflection of the reflected light from the workpiece W. Alternatively, for the material of the aperture plate 30, a ceramic having a high reflectivity and an excellent heat resistance may be used.

The focusing lens 20 and the aperture plate 30 are arranged so that a focal point of the focusing lens 20 is produced at the hole 30a of the aperture plate 30. The laser beam that has passed through the hole 30a of the aperture plate 30 is made incident into the collimator lens 40.

The collimator lens 40 converts the incident laser beam to a collimated light and outputs the same to the first cylindrical lens 51.

The first cylindrical lens 51 (a first optical element, a first focusing lens) has a cylindrical refractive index distribution in a first direction X almost orthogonal to the optical axis direction Z, and has a focusing effect in only one direction being the first direction X. More specifically, the first cylindrical lens 51 focuses a laser beam distributed in the first direction X, but does not focus a laser beam distributed in a second direction Y almost orthogonal to the optical axis direction Z and the first direction X. In this way, the first cylindrical lens 51 has a first focal line 51a formed by focusing of the laser beam distributed in the first direction X. The first focal line 51a is located in front (the side of the laser beam machine 1) of a working surface Wa of the workpiece W in the optical axis direction Z. The first cylindrical lens 51 outputs the focused laser beam to the second cylindrical lens 52.

The second cylindrical lens 52 (a second optical element, a second focusing lens) is arranged apart from the first cylindrical lens 51. The second cylindrical lens 52 has a cylindrical refractive index distribution in the second direction Y, and has a focusing effect in only one direction being the second direction Y. More specifically, the second cylindrical lens 52 focuses a laser beam distributed in the second direction Y, but does not focus a laser beam distributed in the first direction X. In this way, the second cylindrical lens 52 has a second focal line 52a formed by focusing of the laser beam distributed in the second direction Y. The second focal line 52a is located behind (the side opposite the laser beam machine 1) the working surface Wa of the workpiece W in the optical axis direction Z. The second cylindrical lens 52 outputs the focused laser beam almost vertically to the working surface Wa of the workpiece W.

Thus, the first and second cylindrical lenses 51 and 52 function as a focusing portion to impart astigmatism to a laser beam. The positions of the first focal line 51a and the second focal line 52a produced by the astigmatism differ in the optical axis direction Z. And, the working surface Wa of the workpiece W is set at a position sandwiched by the first focal line 51a and the second focal line 52a in the optical axis direction Z.

Due to such a configuration, as shown in FIGS. 1(a) and (b), the light reflected from the working surface Wa of the workpiece W has a beam diameter larger than the diameter of the hole 30a in the aperture plate 30. As a result, a part of the reflected light from the working surface Wa of the workpiece W is blocked by the aperture plate 30, and a return light that returns to the light source 10 through the hole 30a is reduced. Also, the further the first and second focal lines 51a and 52a are distant from the working surface Wa of the workpiece W, the greater the effect to reduce a return light is obtained.

Meanwhile, in an actual operating environment, the positional relationship between the laser beam machine 1 and the workpiece W may change, and at, for example, the time of installation or adjustment of the laser beam machine 1, the time of replacement of the workpiece W, and the like, the position of the working surface Wa of the workpiece W may be coincident with the position of the first focal line 51a in the optical axis direction Z. Then, a beam diameter in the first direction X of the reflected light from the workpiece W is focused to the diameter of the hole 30a in the aperture plate 30. However, since the second focal line 52a is produced at a position different from the position of the working surface Wa of the workpiece W, a beam diameter in the second direction Y of the reflected light from the workpiece W is larger than the diameter of the hole 30a in the aperture plate 30.

Similarly, even when the position of the working surface Wa of the workpiece W is coincident with the position of the second focal line 51a in the optical axis direction Z and a beam diameter in the second direction Y of the reflected light from the workpiece W is focused to the diameter of the hole 30a in the aperture plate 30, since the first focal line 51a is produced at a position different from the position of the working surface Wa of the workpiece W, a beam diameter in the first direction X of the reflected light from the workpiece W is larger than the diameter of the hole 30a in the aperture plate 30.

Therefore, according to the laser beam machine 1 of the first embodiment, without depending on the positional relationship with the workpiece W, the aperture plate 30 blocks a part of the reflected light from the workpiece W, and thus a return light that returns to the light source 10 through the hole 30a can be reduced.

Moreover, according to the laser beam machine 1 of the first embodiment, since the working surface Wa of the workpiece W is set at a position sandwiched by the first focal line 51a and the second focal line 52a in the optical axis direction Z, when, for example, the working surface Wa of the workpiece W is displaced to the side of one of the first and second focal lines 51a and 52a in the optical axis direction Z, the distance between the working surface Wa of the workpiece W and the other of the first and second focal lines 51a and 52a is increased. Accordingly, when the beam diameter in one of the first and second directions X and Y of the reflected light from the workpiece W is reduced, the beam diameter in the other of the first and second directions X and Y is increased. Hence, variation in the effect to reduce a return light to the light source 10 with respect to the positional relationship with the workpiece W can be reduced.

Meanwhile, in the laser beam machine described in Japanese Published Unexamined Patent Application No. S62-289387 mentioned above, reflected light is discharged to the surroundings so as not to return, which is dangerous. However, in the laser beam machine 1 of the first embodiment, since this is constructed so as to return reflected light into the laser beam machine 1 in order to prevent the same from returning to the light source 10 internally, the reflected light is not discharged to the surroundings, which is safe.

Moreover, another patent document (Japanese Published Unexamined Patent Application No. S63-63589) describes a laser beam machine that detects reflected light from a workpiece and controls a laser beam output. According to this laser beam machine, the laser beam output can be reduced when the reflected light from the workpiece is large, and as a result, the intensity of the reflected light returning to a semiconductor laser being a light source can be weakened. However, in this laser beam machine, since the laser beam output changes due to a change in intensity of the reflected light from the workpiece, a uniform laser processing is difficult. On the other hand, according to the laser beam machine 1 of the first embodiment, since a return light to the light source 10 can be reduced without changing the intensity of a laser beam, a uniform laser processing is possible.

Moreover, according to the laser beam machine 1 of the first embodiment, by changing the positional relationship between the first and second focal lines 51a and 52a and the working surface Wa of the workpiece W in the optical axis direction Z, more specifically, by changing the positional relationship between the first and second cylindrical lenses 51 and 52 and the workpiece W in the optical axis direction Z, a beam sectional shape of a laser beam can be easily made into an ellipse, and the longer direction and shorter direction in a beam sectional shape of a laser beam can be easily changed.

Thus, when the beam sectional shape of a laser beam is provided as an ellipse, by changing a scanning direction of the laser beam on the workpiece W, a laser beam machine suitable for a variety of processings can be realized.

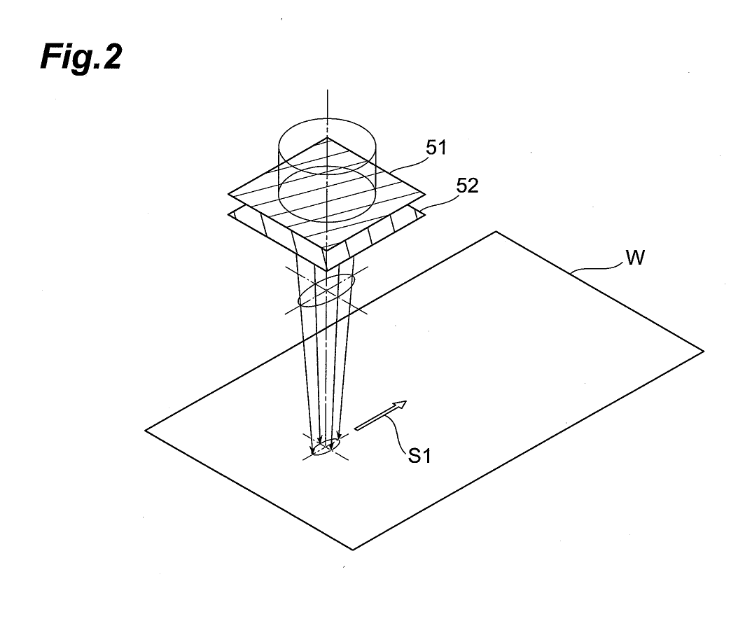

For example, as shown in FIG. 2, when a laser beam is scanned on the workpiece W in a longer direction S1, the laser beam intensity per unit area and unit time can be increased, so that a laser beam machine suitable for a processing, such as cutting or welding, that requires great power per unit area and unit time can be realized.

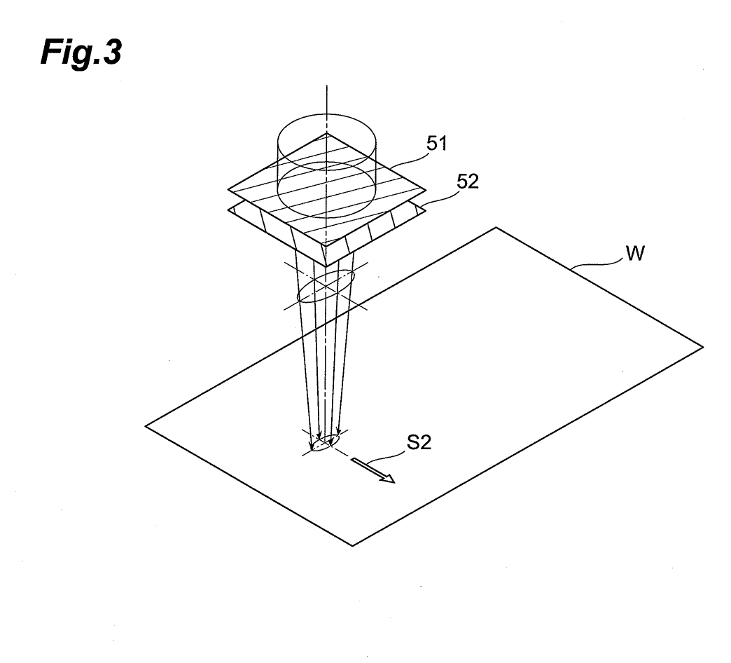

On the other hand, as shown in FIG. 3, when a laser beam is scanned on the workpiece W in a shorter direction S2, the laser beam irradiation area per unit time can be increased, so that a laser beam machine suitable for a processing, such as a surface treatment, that requires a large treatment area per unit time can be realized.

Here, where an average focal length fave=(fzy+fzx)/2 is determined from a geometric-optical focal length fzy on a ZY plane including the first focal line 51a and a geometric-optical focal length fzx on a ZX plane including the second focal line 52a, and an F-number when the diameter of a beam that enters a focusing lens system is provided as d is represented by F=fave/d, the range of a preferably practical astigmatic difference |fzy−fzx| is considered to be 0.01 F<|fzy−fzx|/d<0.2 F.

### Second Embodiment

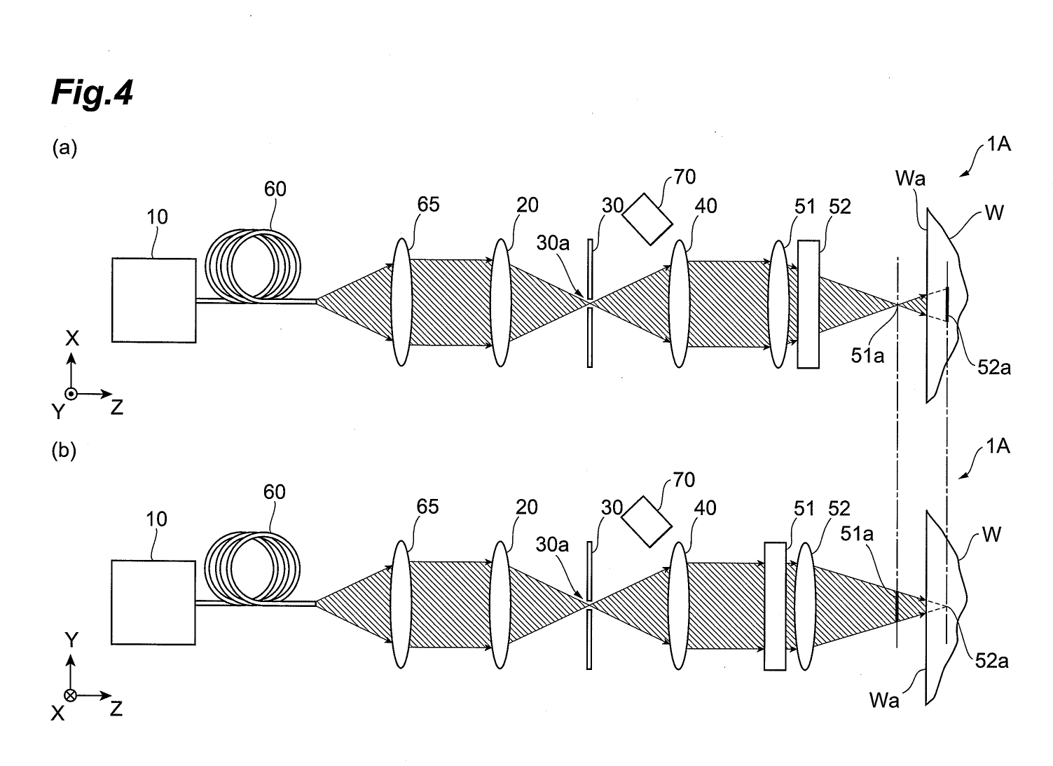

FIG. 4 is a view showing a configuration of a laser beam machine according to a second embodiment of the present invention. FIG. 4(a) is a front view of a laser beam machine 1A, and FIG. 4(b) is a side view of the laser beam machine 1A. Also, in FIGS. 4(a) and (b), shown is a workpiece W along with the laser beam machine 1A.

The laser beam machine 1A differs from the laser beam machine 1 of the first embodiment in the configuration further including an optical fiber 60 (a light guide portion), a collimator lens 65, and a cooler 70. Other aspects of the configuration of the laser beam machine 1A are the same as those of the laser beam machine 1.

One end of the optical fiber 60 is connected to the light source 10, and the other end thereof is arranged toward the optical axis direction Z. The optical fiber 60 guides a laser beam from the light source 10 from one end to the other end and outputs the same to the collimator lens 65.

The collimator lens 65 converts the incident laser beam to a collimated light and outputs the same to the focusing lens 20.

The cooler 70 is provided to cool the aperture plate 30. For the cooler 70, used is an air-cooling fan, a water-cooling heatsink, or the like.

In the laser beam machine 1A of the second embodiment as well, the same advantages as those in the laser beam machine 1 of the first embodiment can be obtained.

Here, when a fiber-guided high-power semiconductor laser as in the laser beam machine 1A is used, there is a risk that not only the semiconductor laser but also an output end portion of the optical fiber may be overheated by a return light to burn out. However, according to the laser beam machine 1A of the second embodiment, since the aperture plate 30 reduces a return light, overheating and burnout of the output end portion of the optical fiber can also be reduced.

Moreover, since the aperture plate 30 blocks a part of the reflected light from the workpiece W, the temperature of the aperture plate 30 rises, and as a result, oxidation may rapidly progress in the aperture plate 30. The reflectivity lowers as oxidation progresses, and the aperture plate 30 begins to absorb more return light. However, according to the laser beam machine 1A of the second embodiment, by including the cooler 70, a rise in temperature of the aperture plate 30 can be suppressed, and as a result, deterioration of the aperture plate 30 can be suppressed.

### Third Embodiment

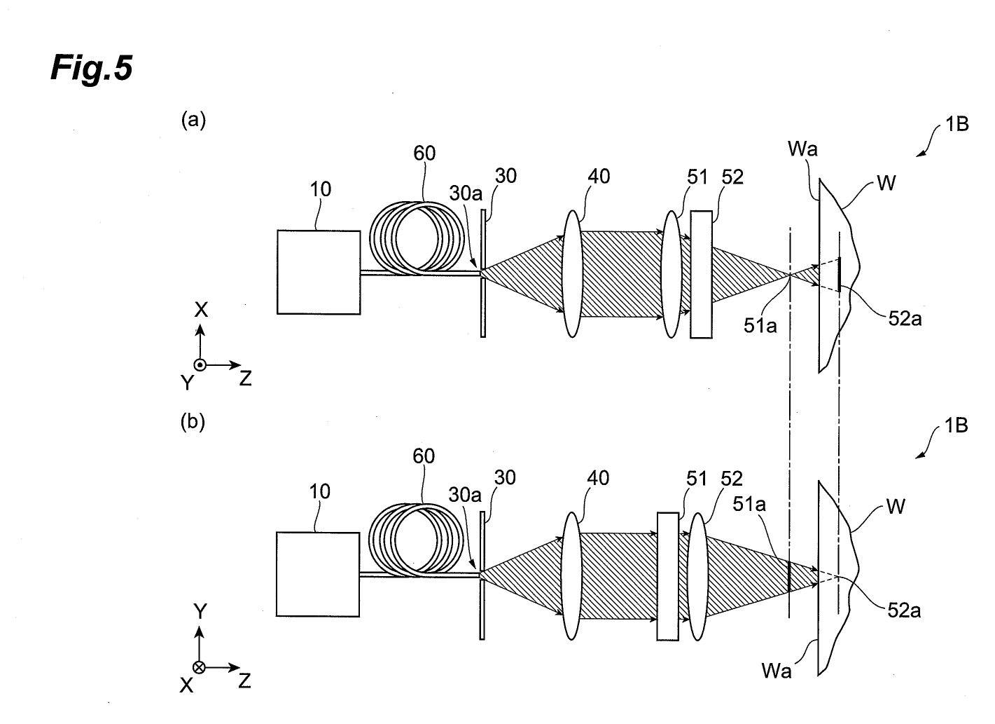

FIG. 5 is a view showing a configuration of a laser beam machine according to a third embodiment of the present invention. FIG. 5(a) is a front view of a laser beam machine 1B, and FIG. 5(b) is a side view of the laser beam machine 1B. Also, in FIGS. 5(a) and (b), shown is a workpiece W along with the laser beam machine 1B.

The laser beam machine 1B differs from the laser beam machine 1A of the second embodiment in the point of not including the focusing lens 20, the collimator lens 65, and the cooler 70. Therefore, the other end of the optical fiber 60 is arranged so as to emit a laser beam toward the hole 30a of the aperture plate 30. Other aspects of the configuration of the laser beam machine 1B are the same as those of the laser beam machine 1A.

In the laser beam machine 1B of the third embodiment as well, the same advantages as those in the laser beam machine 1A of the second embodiment can be obtained.

### Fourth Embodiment

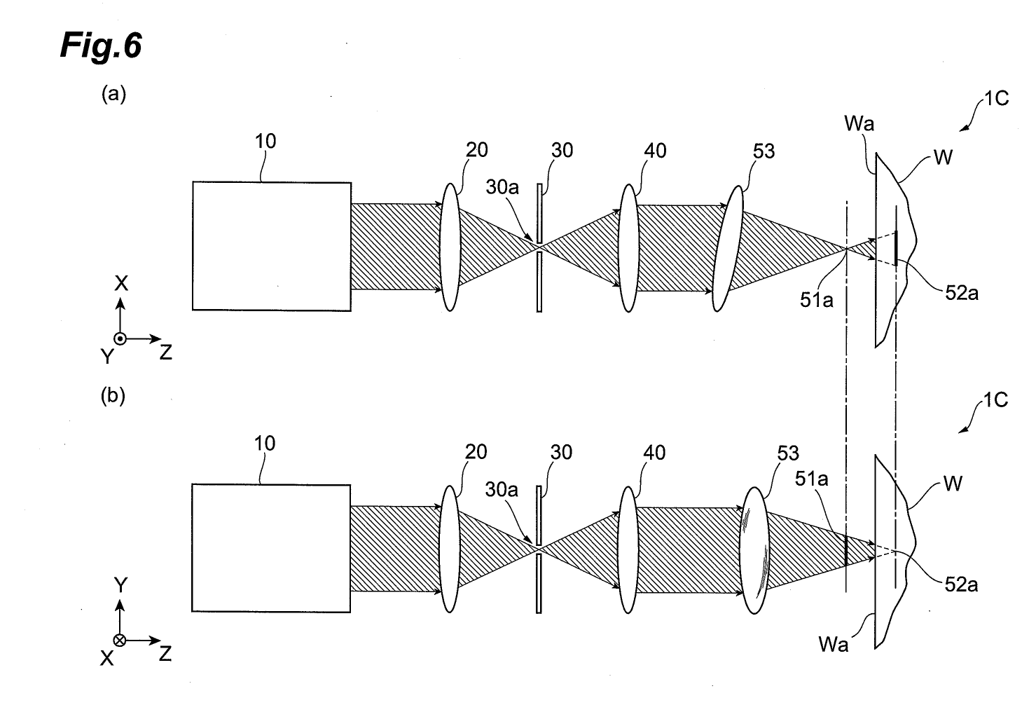

FIG. 6 is a view showing a configuration of a laser beam machine according to a fourth embodiment of the present invention. FIG. 6(a) is a front view of a laser beam machine 1C, and FIG. 6(b) is a side view of the laser beam machine 1C. Also, in FIGS. 6(a) and (b), shown is a workpiece W along with the laser beam machine 1C.

The laser beam machine 1C differs from the laser beam machine 1 of the first embodiment in the configuration including a spherical lens 53 in place of the first and second cylindrical lenses 51 and 52. Other aspects of the configuration of the laser beam machine 1C are the same as those of the laser beam machine 1.

The spherical lens 53 is arranged in a manner inclined from a state of being vertical to the optical axis direction Z. This makes the spherical lens 53 function as a focusing portion to impart astigmatism to a laser beam. And, the first focal line 51a and the second focal line 52a to be produced by the astigmatism are produced at positions to sandwich the working surface Wa of the workpiece W in the optical axis direction Z.

In the laser beam machine 1C of the fourth embodiment as well, the same advantages as those in the laser beam machine 1 of the first embodiment can be obtained.

Also, the present invention is not limited to the present embodiments mentioned above, and various modifications can be made.

In the present embodiments, the two cylindrical lenses 51 and 52 or the spherical lens 53 inclined with respect to the optical axis direction Z have been exemplified as a focusing portion to impart astigmatism, however, various modes are applicable as the focusing portion to impart astigmatism.

For example, in FIG. 1, in place of the first and second cylindrical lenses 51 and 52, a cylindrical lens having a relatively long focal length and an aspherical lens (a second optical element, a second focusing lens) may be provided, respectively. The aspherical lens has an isotropic refractive index distribution on a plane including the first direction X and the second direction Y and thus has an isotropic focusing effect. More specifically, the aspherical lens functions so as to focus light made incident concentrically around the optical axis Z to one point. In this way, the cylindrical lens comes to have the first focal line 51a formed by focusing of a laser beam distributed in the first direction X, and the cylindrical lens and aspherical lens produces the second focal line 52a formed by focusing of a laser beam distributed in the second direction Y. By thus combining the cylindrical lens having a relatively long focal length and an aspherical lens, an astigmatic difference can be generated without producing a strong spherical aberration. Also, the same advantages can be obtained even when an aplanatic lens, an achromatic lens, or the like is used in place of the aspherical lens.

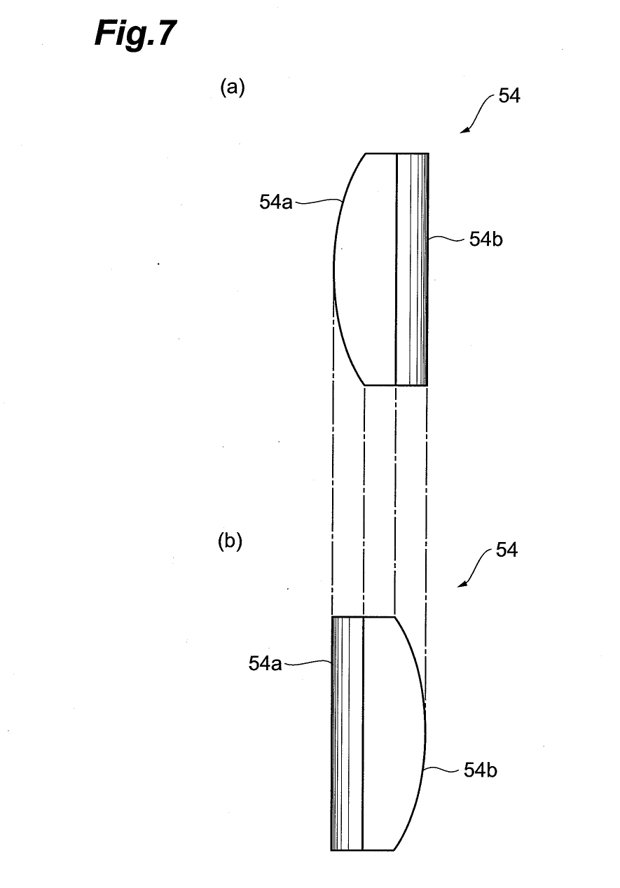

Moreover, as shown in the following, the focusing portion to impart astigmatism may be realized by a single multifocal lens. FIG. 7 is a view showing an example of a multifocal lens for imparting astigmatism. FIG. 7(a) shows a side view of a multifocal lens 54, and FIG. 7(b) shows a side view of the multifocal lens 54 observed from a direction turned by 90 degrees with respect to FIG. 7(a). One surface 54a and the other surface 54b of the multifocal lens 54 form cylindrical surfaces almost orthogonal to each other. This allows the multifocal lens 54, similar to the two cylindrical lenses 51 and 52, to impart astigmatism to a laser beam and, similar to the present embodiments, to produce the first and second focal lines 51a and 52a.

Alternatively, it is also possible to realize the focusing portion to impart astigmatism by a toric lens. Alternatively, for the focusing portion to impart astigmatism, an optical element having, as with a cylindrical lens (concave or convex), a focal power in one direction almost vertical to the optical axis direction Z and a spherical (or aspherical) lens may be used by combination. Alternatively, for the focusing portion to impart astigmatism, an optical element, such as a fresnel lens, a reflecting mirror, a refractive index distribution lens, or a diffraction optical system, having a focal power in one direction almost vertical to the optical axis direction Z may be used while being located almost orthogonal to the optical axis direction Z, or these optical elements such as a fresnel lens, a reflecting mirror, a refractive index distribution lens, and a diffraction optical system may be used by combination. Alternatively, for the focusing portion to impart astigmatism, a multifocal lens for which a diffractive lens and a refractive lens are combined may be used.

In the present embodiments, the aperture plate 30 having the hole 30a as an aperture to block a part of the reflected light from the workpiece W has been exemplified, however, when an LD (Laser Diode) bar or a high-power semiconductor laser for which LD bars are stacked up is used as the semiconductor laser in the light source 10, a slit is preferable to a hole as the aperture, and it is preferable that the size of the slit is adjustable. In the following, an example thereof will be shown.

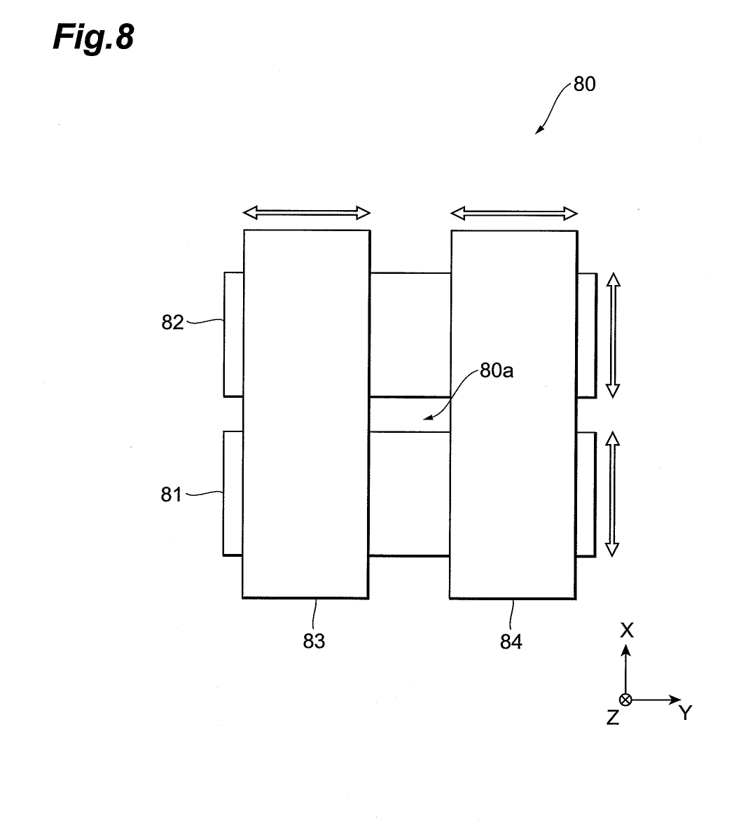

FIG. 8 is a front view showing a modification of an aperture. An aperture 80 shown in FIG. 8 has two flat plates 81 and 82 juxtaposed in the first direction X almost vertical to the optical axis direction Z and two flat plates 83 and 84 juxtaposed in the second direction Y almost vertical to the optical axis direction Z and the first direction X. An area surrounded by these flat plates 81, 82, 83, and 84 forms a slit 80a to pass a laser beam therethrough. The flat plates 81 and 82 are respectively movable in parallel in the first direction X, and the flat plates 83 and 84 are respectively movable in parallel in the second direction Y. This makes the size of the slit 80a adjustable, so that the size of the slit 80a can be easily adjusted to a focused beam sectional shape of a laser beam. Also, for the material of the flat plates 81, 82, 83, and 84, preferably used is a metal such as copper or aluminum having a high reflectivity and a high heat conductivity, a ceramic having a high reflectivity and an excellent heat resistance, or the like.

Moreover, multiple stages of apertures may be provided in the optical axis direction Z. This allows dispersing heat generation caused by a reflected light.

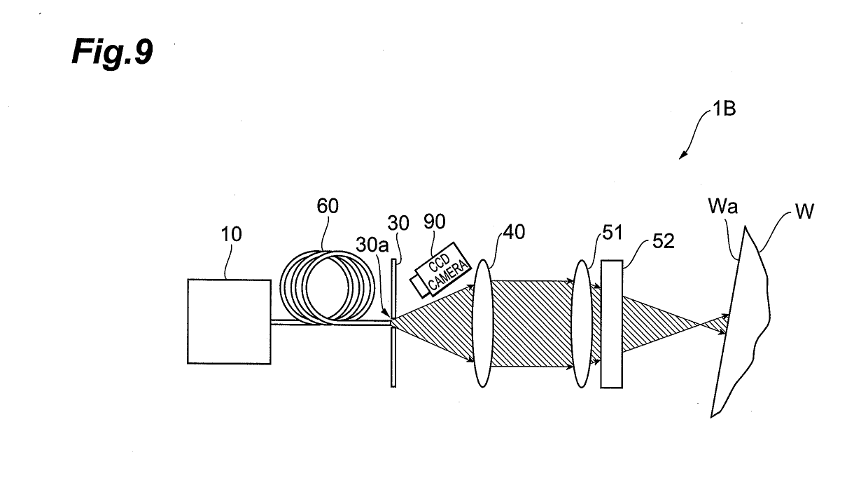

Although, in the third embodiment, the laser beam machine 1B irradiates a laser beam almost vertically onto the working surface Wa of the workpiece W, it is more effective that, as shown in FIG. 9, the laser beam machine 1B irradiates a laser beam onto the working surface Wa of the workpiece W from an oblique direction. This allows reducing a reflected light from the workpiece W returning toward the hole 30a of the aperture plate 30, so that a return light to the light source 10 can be reduced. When a focusing lens not having astigmatism is used as a focusing lens system, if a focal point is formed focused on the working surface Wa of the workpiece W, it is difficult to displace a reflected light from the hole 30a of the aperture plate 30 simply by slightly inclining a laser beam, however, when a focusing lens having astigmatism is used as a focusing lens system as in the present embodiments, a reflected light can be displaced from the hole 30a of the aperture plate 30 simply by slightly inclining a laser beam with respect to the working surface Wa of the workpiece W.

Moreover, the laser beam machine 1B may further have a camera or sensor to observe a reflected light in the periphery of the hole 30a of the aperture plate 30. In FIG. 9, the laser beam machine 1B further includes a CCD camera 90. Thus, when the laser beam machine 1B includes the CCD camera 90, an adjustment and confirmation of the angle when irradiating a laser beam from an oblique direction onto the working surface Wa of the workpiece W can be easily performed, as mentioned above.

Similarly, in the first and second embodiments as well, it is preferable that the laser beam machine 1, 1A irradiates a laser beam onto the working surface Wa of the workpiece W from an oblique direction. Moreover, in the first and second embodiments as well, the laser beam machine 1, 1A may further have a camera or sensor to observe a reflected light in the periphery of the hole 30a of the aperture plate 30.

Although, in the present embodiments, the focusing lens 20, the aperture plate 30, the collimator lenses 40 and 65, and the first and second cylindrical lenses 51 and 52 are arranged almost vertically to the optical axis direction Z, it suffices that these cross even not being vertical thereto. Moreover, although the first and second cylindrical lenses 51 and 52 are arranged so that the refractive index distributions are almost orthogonal to each other, it suffices that these cross even not being orthogonal thereto. More specifically, it suffices that the first and second focal lines 51a and 52a produced due to astigmatism cross even not being orthogonal thereto.

The present invention will be described in greater detail based on examples.

### EXAMPLE 1

A laser beam machine of Example 1 was constructed as follows based on the laser beam machine 1 of the first embodiment.

For a high-power semiconductor laser in the light source 10, stacked LD bars with a wavelength of approximately 980 nm were used. Each LD bar had a length of 1 cm, and was mounted with a fast-axis collimator lens and a slow-axis collimator lens. This LD bar was stacked in five stages at intervals of approximately 2 mm to produce an LD stack. A beam spread angle was approximately 1 degree in the fast axis and approximately 3 degrees in the slow axis. The LD bars had been cooled, and the maximum practical laser output of the 5-stage stack was approximately 250 W.

For the focusing lens 20, a glass aspherical lens having a diameter of 30 mm and an effective focal length of 26 mm was used.

For the aperture plate 30, a pure copper plate having a length and width of 50 mm and a thickness of 1 mm and applied with a gold plating was used. The size of the hole 30a was approximately 0.5 mm in length (fast axis) and approximately 1.5 mm in width. The aperture plate 30 was arranged at a focal position of the focusing lens 20 by use of a manual stage.

For the collimator lens 40, a glass aspherical lens having a diameter of 30 mm and an effective focal length of 26 mm was used as with the focusing lens 20. A laser beam that had passed through the collimator lens 40 was collimated to the same extent as that by the high-power semiconductor laser in the light source 10.

For the first cylindrical lens 51, a glass lens having a length and width of 30 mm and an effective focal length of 60 mm was used. For the second cylindrical lens 52, a glass lens having a length and width of 30 mm and an effective focal length of 50 mm was used. The interval between the first focal line 51a of the first cylindrical lens 51 and the second focal line 52a of the second cylindrical lens 52 was provided as approximately 4 mm.

For the workpiece W, a stainless steel plate having a thickness of 2 mm was used. The stainless steel plate was arranged, almost at the middle of the first focal line 51a and the second focal line 52a, almost vertically with respect to the optical axis direction Z.

As a result of observation with a CCD camera during laser processing, a strong return light was observed in a peripheral portion of the hole 30a of the aperture plate 30. When a return light from the workpiece W directly returns to the LD stack as is, usually, the temperature of the fast-axis collimator lenses, slow-axis collimator lenses, and peripheral portions thereof clearly rises in comparison with when no return light exists (no workpiece W is arranged), while in Example 1, the temperature of those parts was approximately 65° C. (at a laser output of 250 W) regardless of whether the workpiece W existed. Also, this measurement result was obtained by a thermal imaging sensor.

Past experience has shown that a rise in temperature observed in the collimate lenses (fast axis, slow axis) proximal to LD elements and the periphery thereof decreases the life of the LD elements themselves. In the present example, since no rise in temperature due to a return light was observed in the collimate lenses proximal to LDs and the periphery thereof, it can be considered that a reduction in the life of the high-power semiconductor laser due to a return light can be prevented.

### EXAMPLE 2

A laser beam machine of Example 2 was constructed as follows based on the laser beam machine 1A of the second embodiment.

For the light source 10 and the optical fiber 60, a fiber-guided high-power semiconductor laser was used. The high-power semiconductor laser had a wavelength of approximately 980 nm. The optical fiber 60 had a core diameter of 600 μm and an NA of 0.2. The LD elements had been water-cooled, and the maximum practical laser output was approximately 500 W.

For the collimator lens 65, a glass aspherical lens having a diameter of 100 mm and an effective focal length of 100 mm was used. For the focusing lens 20 and the collimator lens 40, glass aspherical lenses each having a diameter of 50 mm and an effective focal length of 40 mm were used.

For the aperture plate 30, a pure copper plate having a diameter of 50 mm and a thickness of 1 mm and applied with a gold plating was used. The size of the hole 30a was approximately 300 μm in diameter. Also, the aperture plate 30 was arranged at a focal position of the focusing lens 20.

For the first cylindrical lens 51, a glass lens having a size of 90 mm×100 mm and an effective focal length of 200 mm was used. For the second cylindrical lens 52, a glass lens having a size of 90 mm×100 mm and an effective focal length of 150 mm was used. The interval between the first focal line 51a of the first cylindrical lens 51 and the second focal line 52a of the second cylindrical lens 52 was provided as approximately 8 mm.

For the workpiece W, a stainless steel plate having a thickness of 5 mm was used. The stainless steel plate was arranged, almost at the middle of the first focal line 51a and the second focal line 52a, almost vertically with respect to the optical axis direction Z.

As a result of observation with a CCD camera during laser processing, a strong return light was observed in a peripheral portion of the hole 30a of the aperture plate 30. The temperature in the vicinity of the output end of the optical fiber was approximately 40° C. (at 500 W) regardless of whether the workpiece W existed. Based on this, it is considered that Example 2 is effective for preventing burnout of the light guiding fiber due to a return light.

As has been described above, according to the present invention, in a laser beam machine, a return light to the light source can be reduced without depending on the positional relationship with the workpiece.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of following claims.

What is claimed is:

1. A laser beam machine comprising:
a light source that emits a laser beam;
an aperture in a flat plate shape and arranged in a manner crossing an optical axis direction of the laser beam from the light source, and having an opening to pass the laser beam from the light source therethrough;
a focusing portion that is arranged at a side opposite to the light source with respect to the aperture, and focuses the laser beam that has passed through the opening of the aperture and irradiates the laser beam onto a workpiece, wherein
the focusing portion imparts astigmatism to the laser beam that has passed through the opening of the aperture,
a first focal line and a second focal line of the focusing portion are produced by the astigmatism,
the first focal line is formed by focusing of a laser beam distributed in a first direction crossing the optical axis direction,
the second focal line is formed by focusing of a laser beam distributed in a second direction crossing the optical axis direction and the first direction, and
positions of the first focal line and the second focal line are different in the optical axis direction.

2. The laser beam machine according to claim 1, wherein a working surface of the workpiece is set at a position sandwiched by the first focal line and the second focal line of the focusing portion in the optical axis direction.

3. The laser beam machine according to claim 1, wherein a beam sectional shape of a laser beam on a working surface of the workpiece is an ellipse.

4. The laser beam machine according to claim 1, further comprising a cooler for the aperture.

5. The laser beam machine according to claim 1, wherein the focusing portion comprises:
a first optical element having a focusing effect in one direction being the first direction; and
a second optical element having a focusing effect in one direction being the second direction.

6. The laser beam machine according to claim 1, wherein the focusing portion comprises:
a first optical element having a focusing effect in one direction being the first direction; and
a second optical element having an isotropic focusing effect on a plane including the first direction and the second direction.

7. The laser beam machine according to claim 5, wherein
the first optical element includes a first focusing lens that is arranged in a manner crossing the optical axis direction, and produces the first focal line as a result of having a cylindrical refractive index distribution in the first direction, and
the second optical element includes a second focusing lens that is arranged in a manner crossing the optical axis direction and arranged apart from the first focusing lens in the optical axis direction, and produces the second focal line as a result of having a cylindrical refractive index distribution in the second direction.

8. The laser beam machine according to claim 6, wherein
the first optical element includes a first focusing lens that is arranged in a manner crossing the optical axis direction, and produces the first focal line as a result of having a cylindrical refractive index distribution in the first direction,
the second optical element includes a second focusing lens that is arranged in a manner crossing the optical axis direction and arranged apart from the first focusing lens in the optical axis direction, and has an isotropic refractive index distribution on a plane including the first direction and the second direction, and
the focusing portion produces the second focal line by focusing effects of the first focusing lens and the second focusing lens.

9. The laser beam machine according to claim 1, wherein the focusing portion comprises:
a multifocal lens that is arranged in a manner crossing the optical axis direction, and produces the first and second focal lines as a result of having refractive index distributions in the first and second directions, respectively.

10. The laser beam machine according to claim 1, wherein the focusing portion comprises:
a spherical lens arranged in a manner crossing the optical axis direction and arranged in a manner inclined with respect to the optical axis direction.
